(19) United States
(12) Patent Application Publication
(10) Pub. No.: US 2024/0359956 A1
(43) Pub. Date: Oct. 31, 2024

(54) CONTAINER SUPPORTING ASSEMBLY

(71) Applicant: SlurryMonster, LLC, Livonia, MI (US)

(72) Inventor: Ryan Klacking, Canton, MI (US)

(21) Appl. No.: 18/649,228

(22) Filed: Apr. 29, 2024

Related U.S. Application Data
(60) Provisional application No. 63/498,909, filed on Apr. 28, 2023.

(51) Int. Cl. B66F 5/02; B65F 1/14; B65F 3/00

(52) U.S. Cl. CPC B66F 5/02; B65F 1/141; B65F 3/005

(57) ABSTRACT

A container supporting assembly includes a pair of sleeves extending from a body portion for accepting tines on a pallet jack, a tower extending from the body portion to a cross support, and a pair of container support arms connected to the cross support for supporting a container.

### CROSS REFERENCED TO RELATED APPLICATIONS

This application claims priority to U.S. Provisional Application No. 63/498,909, filed Apr. 28, 2023.

### BACKGROUND

Containers for collecting waste can include rigid sided containers that can be filled and disposed of with the waste. However, rigid sided containers require a significant volume for transporting when empty and therefore include higher purchase expenses and delivery expenses.

A pallet jack, also known as a pallet truck or pallet pump, is a tool used to lift and move pallets. A pallet is a flat transport structure for supporting goods in a stable fashion while being lifted, such as by a pallet jack.

### SUMMARY

In some aspects, the examples described herein relate to a container supporting assembly including: a pair of sleeves extending from a body portion for accepting tines on a pallet jack, a tower extending from the body portion to a cross support, and a pair of container support arms connected to the cross support for supporting a container.

In some aspects, the examples described herein relate to an assembly, in which the pair of container support arms are pivotably connected to the cross support through a pair of pivoting supports.

In some aspects, the examples described herein relate to an assembly, in which the tower is height adjustable to adjust the height of the cross support.

In some aspects, the examples described herein relate to an assembly, in which the tower includes a central shaft and a telescoping shaft received within the central shaft.

In some aspects, the examples described herein relate to an assembly, in which the cross support extends in a widthwise direction, the pair of arms are spaced from one another in the widthwise direction, and the pair of sleeves are spaced from one another in the widthwise direction.

In some aspects, the examples described herein relate to an assembly, in which the pair of container support arms are pivotably connected to the cross support through a pair of pivoting supports.

In some aspects, the examples described herein relate to an assembly, in which the pair of pivoting supports are pivotable between a first position in which the arms are spaced apart a first width, and a second position in which the arms are spaced apart a second width, and the first width is greater than the second width.

In some aspects, the examples described herein relate to an assembly, in which the pair of pivoting supports are each held in the first position by a retention pin.

In some aspects, the examples described herein relate to an assembly, in which the arms are at a greater height in the first position than in the second position.

In some aspects, the examples described herein relate to an assembly, in which the arms are substantially perpendicular to the cross support in both the first position and the second position.

In some aspects, the examples described herein relate to an assembly, in which sleeves are substantially perpendicular to the cross support.

In some aspects, the examples described herein relate to an assembly, including a retention pin to interface with the cross support to retain one of the pair of pivoting supports in the first position.

In some aspects, the examples described herein relate to an assembly, in which the body portion extends in the widthwise direction.

In some aspects, the examples described herein relate to an assembly, in which a height of at least one of the pair of container support arms is adjustable.

In some aspects, the examples described herein relate to an assembly, in which a width between the pair of container support arms is adjustable.

In some aspects, the examples described herein relate to an assembly, in which a height of at least one of the pair of container support arms is adjustable.

In some aspects, the examples described herein relate to an assembly, in which the tower is height adjustable to adjust the height of the cross support.

In some aspects, the examples described herein relate to an assembly, in which the tower includes a central shaft and a telescoping shaft received within the central shaft.

In some aspects, the examples described herein relate to a container supporting assembly including: a height adjustable tower extending from a body portion to a cross support, the cross support and the body portion extending in a widthwise direction. A pair of sleeves are spaced apart in the widthwise direction and extend substantially perpendicularly from the body portion for accepting tines on a pallet jack. A pair of container support arms are spaced apart in the widthwise direction and are connected to, and substantially perpendicular to, the cross support for supporting a container. A pair of pivoting supports connect the pair of container support arms to the cross support and are configured to pivot between a first position and a second position. The pair of container support arms are spaced apart a first distance in the widthwise direction in the first position, and a second distance in the widthwise direction in the second position, the first distance being greater than the second distance. The pair of container support arms are at a first height in the first position and a second height in the second position, and the first height is greater than the second height.

In some aspects, the examples described herein relate to a container supporting assembly including: a height adjustable tower extending from a body portion to a cross support, the cross support and the body portion extending in a widthwise direction. A pair of sleeves are spaced apart in the widthwise direction and extend substantially perpendicularly from the body portion for accepting tines on a pallet jack. A pair of container support arms are spaced apart in the widthwise direction and are connected to, and substantially perpendicular to, the cross support for supporting a container. A pair of pivoting supports connect the pair of container support arms to the cross support to adjust a height of the pair of container support arms and the widthwise spacing between the pair of container support arms.

These and other features may be best understood from the following specification and drawings, the following of which is a brief description.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates a container supporting assembly located on a pallet jack.

FIG. 2 illustrates a top view of the container supporting assembly of FIG. 1.

FIG. 3 illustrates the container supporting assembly of FIG. 1 in a first position with a first container located on a pallet.

FIG. 4 illustrates the container supporting assembly of FIG. 2 in a second position with a second container located on another pallet.

FIG. 5 illustrates a method of using the container supporting assembly.

### DETAILED DESCRIPTION

The present disclosure relates to a container supporting assemblies and methods, and more particularly, to assemblies that attach to a pallet jack and at least partially support a container.

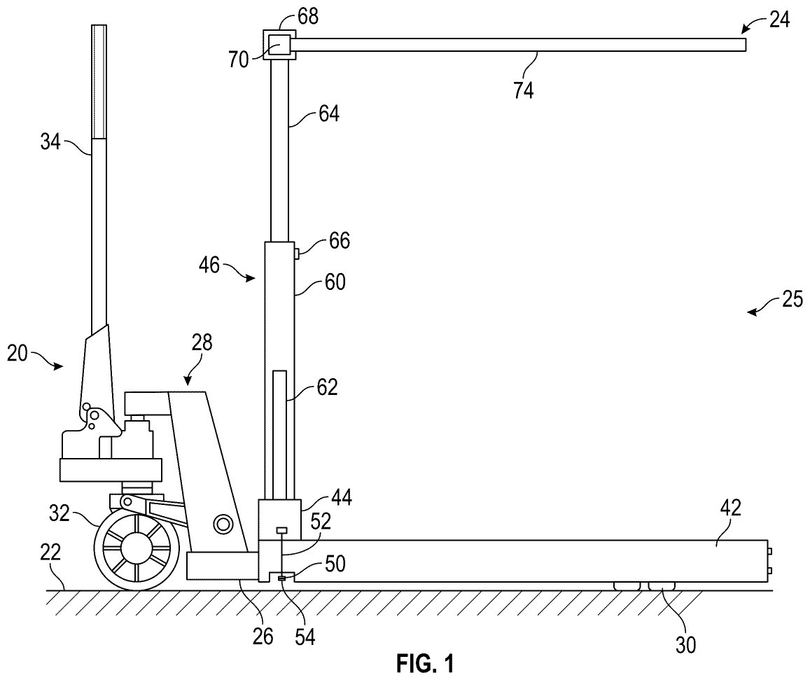

In situations where waste is being removed, such as at construction sites, the waste is generally collected in a container near the point of waste generation and then moved to another larger storage location on site. While traditional hard sided waste containers can easily support large amounts of waste, they are expensive for single use disposal applications and require a significant amount of space for storage and transport to the construction site. Collapsible soft sided bags or totes can be folded into a small space and are less expensive for single use applications, but are more difficult to handle when filling. In particular, the collapsible soft sided bags are supported when filled. In some instances, the tines on a fork truck are used to hang collapsible bags. However, this requires a fork truck for every collapsible bag and there are some environments where a fork truck cannot be used due to its size or emissions. FIGS. 1-4 of the present disclosure are directed to a container supporting assembly 24 for supporting a collapsible bag that is movable by a pallet jack 20.

As shown in FIGS. 1-4, the pallet jack 20 is located on a floor surface 22 and engages the container supporting assembly 24. In the illustrated example, the pallet jack 20 includes a pair of tines 26 extending from a body portion 28. The pallet jack 20 is supported adjacent distal ends of the tines 26 by rollers 30 and by one or more pivoting wheels 32 adjacent the body portion 28. The pivoting wheel 32 allows a user of the pallet jack 20 to maneuver the pallet jack 20 in different directions along the floor surface 22. The pivoting wheel 32 is connected to a handle 34 moves the pivoting wheel 32 into a desired direction of travel. The handle 34 also facilitates raising and lowering the tines 26, such as through hydraulic pressure generated in a hydraulic cylinder.

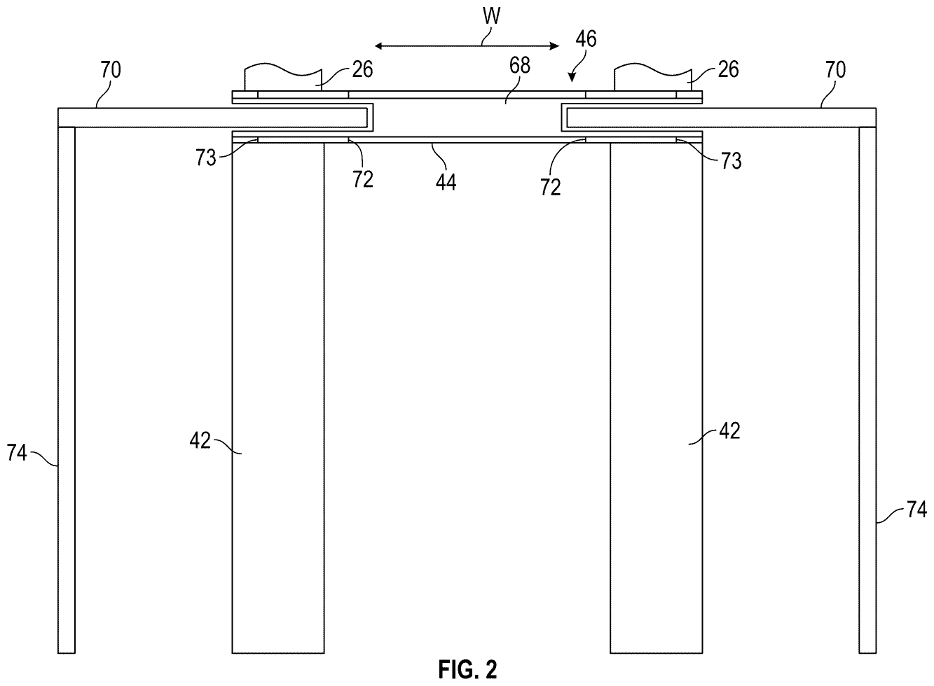

The container supporting assembly 24 includes a body portion 44 having a pair of sleeves 42 extending from opposing ends of the body portion 44 toward an end 25 of the container supporting assembly 24 and a tower 46 that extends from a central region of the body portion 44 between the sleeves 42. In some examples, as shown, the sleeves 42 extend perpendicularly from the central body portion 44 and are spaced from each other by a width that corresponds to a width of the tines 26 to allow the sleeves 42 to fit over the tines 26 as shown in FIGS. 1 and 2. In some examples, as shown, the sleeves 42 extend a majority of a length of the tines 26. In some examples, the sleeves 42 extend a length of the tines 26 from the body portion 28 of the pallet jack 20 to the rollers 30. In another example, the sleeves 42 extend a distance from the body portion 28 of the pallet jack 20 past the rollers 30. One feature of having the sleeves 42 extend at least a majority of the length of the tines 26 may be stability of the container supporting assembly 24 relative to the pallet jack 20.

Furthermore, at least one sleeve retainer, such as a retainer plate 50, can further secure the container supporting assembly 24 to the tines 26. The retainer plate 50 includes a width greater than a width of the sleeves 42 and in the illustrated example is fixed relative to the body portion 44 by fasteners 52. The fasteners 52 can include bolts that secure the retainer plate 50 to the body portion 44 with nuts 54 that are removably attached to the fasteners 52.

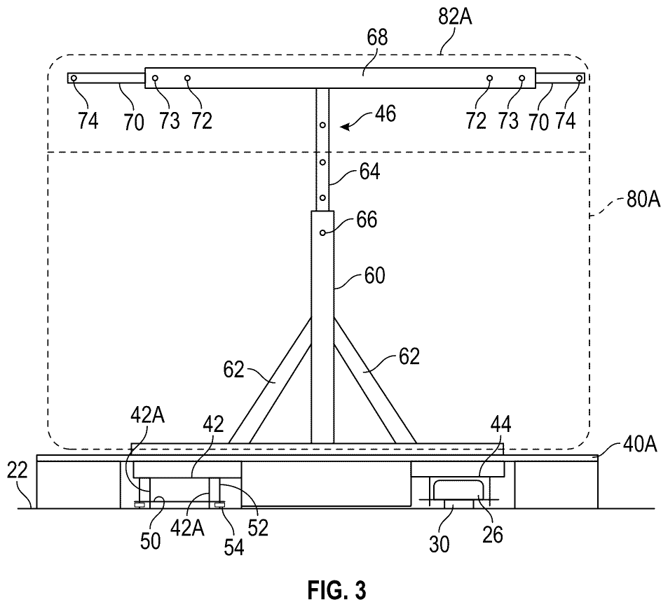

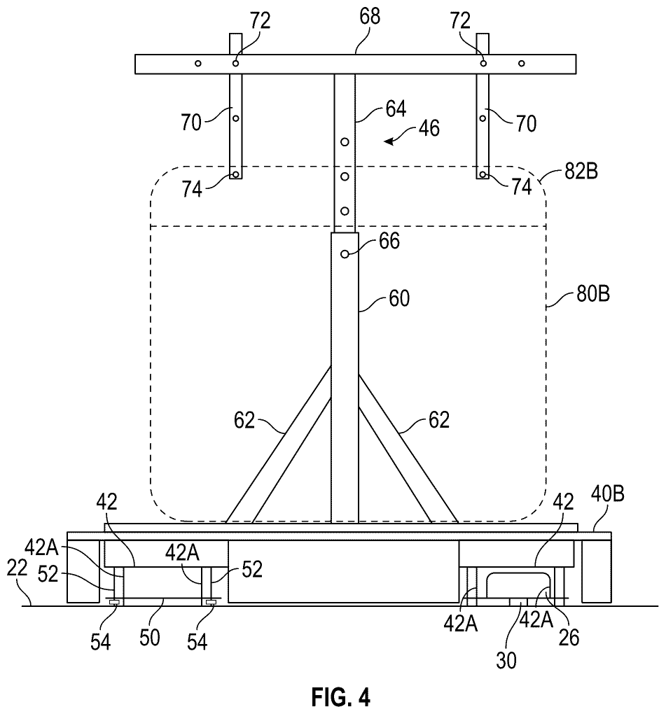

Additionally, as shown in FIGS. 3 and 4, sidewalls 42A of the sleeves 42 can be of a sufficient height to allow the tines 26 to be rolled into sleeves 42 when the tines 26 are in the lowest position. Alternatively, in some examples, the container supporting assembly 24 can be lifted and placed onto the tines 26.

The example tower 46 on the container supporting assembly 24 may include a central shaft 60 that extends upward from the body portion 44 and is supported by a pair of gussets 62. The example tower 46 may be height adjustable. In some examples, as shown, a telescoping shaft 64 may be sized to fit within the central shaft 60 and be secured at a desired height by a pin 66 that extends through corresponding holes in the central shaft 60 and the telescoping shaft 64.

One or more arms 74 may support a container 80. In some examples, as shown, at an opposite end of the telescoping shaft 64 from the central shaft 60 is a cross support 68 that is rigidly fixed to the telescoping shaft 64 and extends perpendicularly to the telescoping shaft 64. A pivoting support 70 may be located adjacent each opposing end of the cross support 68 and include an arm 74 that is used to support a container 80 hanging from the pivoting support 70. In some examples, as shown, the pivoting support 70 pivots about pins 72 that extend through the cross support 68 and a corresponding one of the pivoting supports 70. The pivoting supports 70 can be secured relative to the cross support 68 such that the pivoting supports 70 extend in the same direction or parallel to the cross support 68 with a retention pin 73 (FIG. 3) or allowed to pivot downward (FIG. 4). One feature of having the pivoting supports 70 movable relative to the cross support 68 is that the container supporting assembly 24 can accommodate containers 80 of different height and width.

The arms 74 extend from their respective pivoting supports 70 toward the end 25. In some examples, the arms 74 may be substantially the same length (±20%) as the sleeves 42. The arms 74 and sleeves 42 may be substantially perpendicular (±5°) to one or both of the shafts 60, 64. The arms 74 and sleeves 42 may be substantially perpendicular (±5°) to the cross support 68. The arms 74 and sleeves 42 may be substantially perpendicular (±5°) to the cross support 68 in the positions shown in both FIG. 3 and FIG. 4. The example cross support 68 extends in a widthwise direction w, the example arms 74 are spaced in the widthwise direction w from one another (see FIG. 2), and the example sleeves 42 are spaced in the widthwise direction w from one another. The pivoting supports 70 may be pivoted to adjust one or both of the width between the arms 74 and the height of the arms 74. The pivoting axis of the pivoting support 70 may be substantially perpendicular to the cross support 68.

In particular, as shown in FIG. 3, a container 80A, such as a collapsible or foldable canvas or synthetic fiber bag, is supported along its base by the pallet 40A and maintained in an upright position by a strap 82A that extends from a portion of the container 80A over the arms 74 on the pivoting supports 70. One feature of this arrangement is that the container supporting assembly 24 only needs to support a portion of the weight of the container 80A and the contents with the remainder, which may be the majority, of the weight being supported by the pallet 40A. Additionally, with the pallet 40A is supporting a majority of the weight from the container 80A and waste, the tines 26 on the pallet jack 20 can be lowered to allow the container supporting assembly 24 to be separated from the container 80A and pallet 40A once sufficiently filled. Alternatively, the pivoting support 70 can be allowed to pivot about pin 72 to further release any forces carried by the arms 74 to allow separation of the supporting assembly 24 from the container 80A. This allows the container 80A and pallet 40A to be moved to an area that is accessible for a fork truck.

Similarly, as shown in FIG. 4, the same container supporting assembly 24 can be used to support a container 80B on a pallet 40B that is smaller than the container 80A and pallet 40A, respectively, by allowing the pivoting supports 70 to pivot downward, such as by releasing the retention pin 73. The container supporting assembly 24 can then be removed from the pallet 40B and container 80B as described above. Compared with the position shown in FIG. 3, the width between the arms 74 is lesser and the height of the arms 74 is lesser in the position shown in FIG. 4.

As shown in FIGS. 3 and 4, the sleeves 42 of the container supporting assembly 24 can fit within openings on a pallet 40A/40B for the tines 26 of the pallet jack 20. Although only a single tine 26 on the pallet jack 20 is illustrated in FIGS. 3 and 4, both the tines 26 would fit within the respective sleeves 42 as described above to raise or lower the pallet 50 for moving the pallet 50 on the floor surface 22.

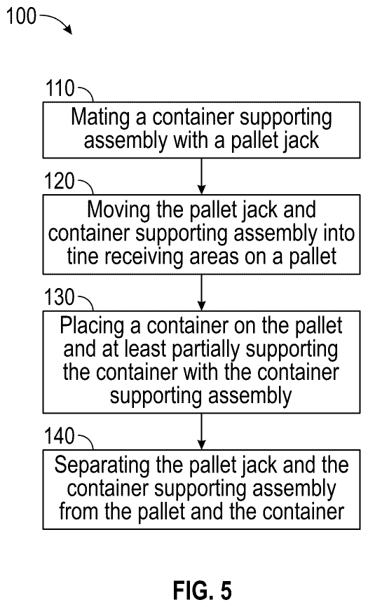

FIG. 5 illustrates a method 100 of using the container supporting assembly 24, which may be utilized with any of the examples disclosed herein. Fewer or additional steps than are recited below could be performed within the scope of this disclosure, and the recited order of steps is not intended to limit this disclosure.

In block 110, the container supporting assembly 24 is mated with the pallet jack 20. The pallet jack 20 and the container supporting assembly 24 can be moved into the tine receiving areas on the pallet 40 (Block 120). The container 30 can be placed on the pallet 40 with the straps 82 placed over the arms 74 to at least partially support the container 80 (Block 130). The pallet jack 20 can be lowered to separate the pallet jack 20 and the container supporting assembly 24 from the pallet 40 (Block 140). In some examples, this step can be performed once the container 80 is full.

In certain contexts, the examples discussed herein involve assemblies for supporting containers. An example assembly may be said to include a tower that may be adjustable in height, extending from a main body to a cross support. Both the cross support and the main body extend widthwise. Two sleeves, spaced apart in the widthwise direction, extend substantially perpendicularly from the main body to accommodate the tines of a pallet jack. Additionally, two container support arms, also spaced apart widthwise, connect to the cross support at a perpendicular angle to support the container. Pivoting supports may connect the arms to the cross support, enabling the arms to pivot between two or more positions. In a first position, the arms are spaced apart at a greater widthwise distance and positioned at a greater height compared to a second position.

In another example, a container support assembly may include a tower that may be adjustable in height, extending from a central body to a cross support, with both the cross support and the body spanning in a widthwise direction. Two sleeves are positioned at intervals along the width, extending at right angles from the central body to accommodate the tines of a pallet jack. Two arms for container support, also spaced from one another along the width, are attached perpendicularly to the cross support. Two pivoting supports link the arms to adjust one or both of their height and their spacing along the width.

Although the different examples are illustrated as having specific components, the examples of this disclosure are not limited to those particular combinations. It is possible to use some of the components or features from any of the embodiments in combination with features or components from any of the other embodiments.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A container supporting assembly, comprising:
a pair of sleeves extending from a body portion for accepting tines on a pallet jack;
a tower extending from the body portion to a cross support; and
a pair of container support arms connected to the cross support for supporting a container.

2. The assembly of claim 1, wherein the pair of container support arms are pivotably connected to the cross support through a pair of pivoting supports.

3. The assembly of claim 1, wherein the tower is height adjustable to adjust the height of the cross support.

4. The assembly of claim 3, wherein the tower includes a central shaft and a telescoping shaft received within the central shaft.

5. The assembly of claim 1, wherein the cross support extends in a widthwise direction, the pair of arms are spaced from one another in the widthwise direction, and the pair of sleeves are spaced from one another in the widthwise direction.

6. The assembly of claim 5, wherein the pair of container support arms are pivotably connected to the cross support through a pair of pivoting supports.

7. The assembly of claim 6, wherein the pair of pivoting supports are pivotable between a first position in which the arms are spaced apart a first width, and a second position in which the arms are spaced apart a second width, and the first width is greater than the second width.

8. The assembly of claim 7, wherein the pair of pivoting supports are each held in the first position by a retention pin.

9. The assembly of claim 7, wherein the arms are at a greater height in the first position than in the second position.

10. The assembly of claim 9, wherein the arms are substantially perpendicular to the cross support in both the first position and the second position.

11. The assembly of claim 10, wherein sleeves are substantially perpendicular to the cross support.

12. The assembly of claim 9, comprising a retention pin to interface with the cross support to retain one of the pair of pivoting supports in the first position.

13. The assembly of claim 5, wherein the body portion extends in the widthwise direction.

14. The assembly of claim 1, wherein a height of at least one of the pair of container support arms is adjustable.

15. The assembly of claim 1, wherein a width between the pair of container support arms is adjustable.

16. The assembly of claim 15, wherein a height of at least one of the pair of container support arms is adjustable.

17. The assembly of claim 16, wherein the tower is height adjustable to adjust the height of the cross support.

18. The assembly of claim 17, wherein the tower includes a central shaft and a telescoping shaft received within the central shaft.

19. A container supporting assembly, comprising:
a height adjustable tower extending from a body portion to a cross support, the cross support and the body portion extending in a widthwise direction;
a pair of sleeves spaced apart in the widthwise direction and extending substantially perpendicularly from the body portion for accepting tines on a pallet jack;
a pair of container support arms spaced apart in the widthwise direction and connected to, and substantially perpendicular to, the cross support for supporting a container; and
a pair of pivoting supports connecting the pair of container support arms to the cross support configured to pivot between a first position and a second position,
wherein the pair of container support arms are spaced apart a first distance in the widthwise direction in the first position, and a second distance in the widthwise direction in the second position, the first distance greater than the second distance, the pair of container support arms are at a first height in the first position and a second height in the second position, and the first height is greater than the second height.

20. A container supporting assembly, comprising:
a height adjustable tower extending from a body portion to a cross support, the cross support and the body portion extending in a widthwise direction;
a pair of sleeves spaced apart in the widthwise direction and extending substantially perpendicularly from the body portion for accepting tines on a pallet jack;
a pair of container support arms spaced apart in the widthwise direction and connected to, and substantially perpendicular to, the cross support for supporting a container; and
a pair of pivoting supports connecting the pair of container support arms to the cross support adjust a height of the pair of container support arms and the widthwise spacing between the pair of container support arms.
